(19) United States
(12) Patent Application Publication
(10) Pub. No.: US 2025/0175860 A1
(43) Pub. Date: May 29, 2025

(54) INTEGRATED ACCESS AND BACKHAUL NODE MIGRATION METHOD AND APPARATUS

(71) Applicant: ZTE Corporation, Shenzhen, Guangdong (CN)

(72) Inventors: Ying HUANG, Shenzhen (CN); Lin CHEN, Shenzhen (CN)

(21) Appl. No.: 19/037,893

(22) Filed: Jan. 27, 2025

Related U.S. Application Data
(63) Continuation of application No. PCT/CN2022/110939, filed on Aug. 8, 2022.

(51) Int. Cl. H04W 36/00; H04W 36/32

(52) U.S. Cl. CPC H04W 36/0055; H04W 36/324

(57) ABSTRACT

A method of wireless communication is described. A method of wireless communication, comprising transmitting, from an integrated access and backhaul (IAB) node to an IAB donor, IAB node mobility status information.

### PRIORITY CLAIM AND CROSS REFERENCE TO RELATED APPLICATION

This patent document is a continuation application of, and claims the benefits of priority to, under 35 U.S.C. § 120, the International Patent Application No. PCT/CN2022/110939 of the same tile, filed on Aug. 8, 2022 and published as PCT publication No. PCT WO/2024/031265 on Feb. 15, 2024. The entire content of the before-mentioned patent application is incorporated by reference as part of the disclosure of this application.

### TECHNICAL FIELD

This patent document generally relates to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems with respect to migration of an integrated access and backhaul (IAB) node.

In one example aspect, a wireless communication method is disclosed. The method includes transmitting, from an integrated access and backhaul (IAB) node to an IAB donor, IAB node mobility status information.

In another example aspect, another wireless communication method is disclosed. The method includes transmitting, from a wireless device to an integrated access and backhaul (IAB) entity, wireless device mobility status information.

In another example aspect, another wireless communication method is disclosed. The method includes transmitting, from an integrated access and backhaul (IAB) donor to an IAB Mobile node, migration related configuration information; and wherein the migration related configuration information includes at least one of the following: DU migration indication; F1 setup indication, conditional configuration indication for IAB-Mobile Terminal (MT) migration, IAB-MT migration, IAB-MT migration withhold indication, IP address information allocated by source IAB donor, IP address information allocated by target IAB donor, or topology indication.

In another example aspect, another wireless communication method is disclosed. The method includes receiving, by an integrated access and backhaul (IAB) node, from an IAB donor, cell reselection configuration information; and wherein the cell reselection configuration information includes at least one of the following: speed dependent scaling parameter based on the relative speed, speed dependent scaling mechanism enable indication, or speed dependent scaling mechanism disable indication.

In another example aspect, another wireless communication method is disclosed. The method includes receiving, by the wireless device, from an integrated access and backhaul (IAB) entity, cell reselection configuration information; and wherein the cell reselection configuration information includes at least one of the following: speed dependent scaling parameter based on the relative speed, speed dependent scaling mechanism enable indication, or speed dependent scaling mechanism disable indication.

In another example aspect, another wireless communication method is disclosed. The method includes transmitting, by an integrated access and backhaul (IAB) node, the IAB node mobility status information; and wherein the mobility status information includes at least one of the following: speed information, direction information, serving onboard wireless device indication, serving surrounding wireless devices indication, location information, speed dependent scaling parameter that is based on the relative speed, or threshold of speed of IAB node. In another example aspect, another wireless communication method is disclosed.

The method includes receiving, by an integrated access and backhaul (IAB) donor, from an IAB node, IAB node mobility status information; and communicating with the IAB node according to the IAB node mobility status information.

In another example aspect, another wireless communication method is disclosed. The method includes receiving, by an integrated access and backhaul (IAB) entity, from a wireless device, wireless device mobility status information; and communicating with the wireless device according to the wireless device mobility status information.

In another example aspect, another wireless communication method is disclosed. The method includes transmitting, from an integrated access and backhaul (IAB) donor to an IAB Mobile node, migration related configuration information; and wherein the migration related configuration information includes at least one of the following: DU migration indication, F1 setup indication, conditional configuration indication for IAB-Mobile Terminal (MT) migration, IAB-MT migration, IAB-MT migration withhold indication, IP address information allocated by source IAB donor, IP address information allocated by target IAB donor, or topology indication.

In another example aspect, another wireless communication method is disclosed. The method includes transmitting, from an integrated access and backhaul (IAB) donor to an IAB node, from the IAB donor, cell reselection configuration information; and wherein the cell reselection configuration information includes at least one of the following: speed dependent scaling parameter based on the relative speed, speed dependent scaling mechanism enable indication, or speed dependent scaling mechanism disable indication.

In another example aspect, another wireless communication method is disclosed. The method includes transmitting, from an integrated access and backhaul (IAB) entity to the wireless device, cell reselection configuration information; and wherein the cell reselection configuration information includes at least one of the following: speed dependent scaling parameter based on the relative speed, speed dependent scaling mechanism enable indication, or speed dependent scaling mechanism disable indication.

In another example aspect, another wireless communication method is disclosed. The method includes receiving from an integrated access and backhaul (IAB) node, the IAB node mobility status information; and wherein the mobility status information includes at least one of the following: speed information, direction information, serving onboard wireless device indication, serving surrounding wireless devices indication, location information, speed dependent scaling parameter that is based on the relative speed, or threshold of speed of IAB node.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 shows an example of a wireless communication system that includes a base station (BS) and user equipment (UE).

FIG. 2 is a block diagram example of a wireless communication system.

FIG. 3 shows an example of mobile IAB scenario.

FIG. 4 shows an example of IAB architecture.

FIG. 5 shows an example of Parent- and child-node relationship for IAB-node.

FIG. 6 shows an example of inter-donor migration.

FIG. 7 is a flowchart illustrating an example method.

FIG. 8 is a flowchart illustrating an example method.

FIG. 9 is a flowchart illustrating an example method.

FIG. 10 is a flowchart illustrating an example method.

FIG. 11 is a flowchart illustrating an example method.

FIG. 12 is a flowchart illustrating an example method.

FIG. 13 is a flowchart illustrating an example method.

FIG. 14 is a flowchart illustrating an example method.

FIG. 15 is a flowchart illustrating an example method.

FIG. 16 is a flowchart illustrating an example method.

FIG. 17 is a flowchart illustrating an example method.

FIG. 18 is a flowchart illustrating an example method.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

Integrated Access and Backhaul (IAB) supports wireless backhauling via new radio (NR) enabling flexible and very dense deployment of NR cells while reducing the need for wireline transport infrastructure. Intra-donor CU migration procedure has been studied and specified in R16 IAB in which both the source and the target parent node are served by the same IAB-donor-CU. And inter-donor CU migration was discussed in R17 IAB where the migrating IAB node is static. However, there is no solution for inter-donor migration in mobile IAB use case. In mobile IAB use case, IAB nodes are mounted in vehicles and can provide 5G coverage/capacity enhancement to onboard and/or surrounding UEs.

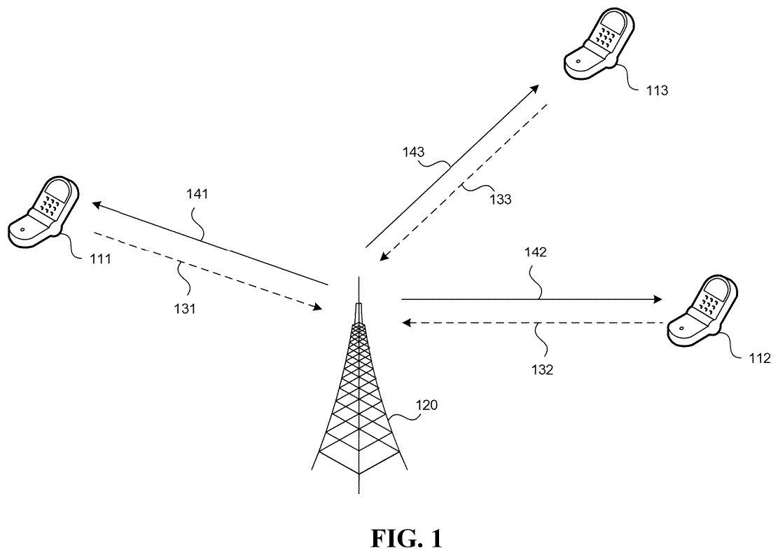

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

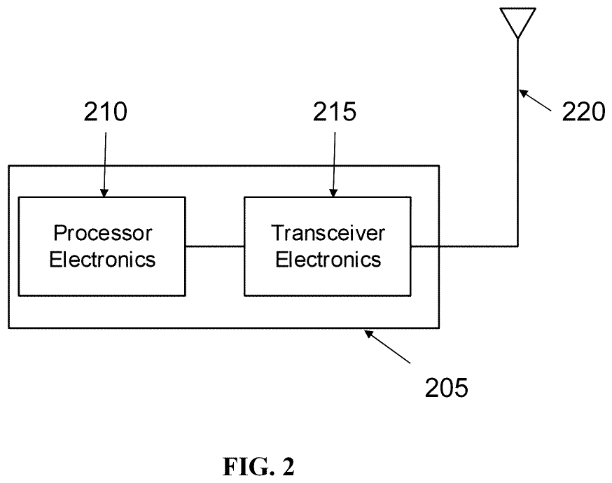

FIG. 2 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

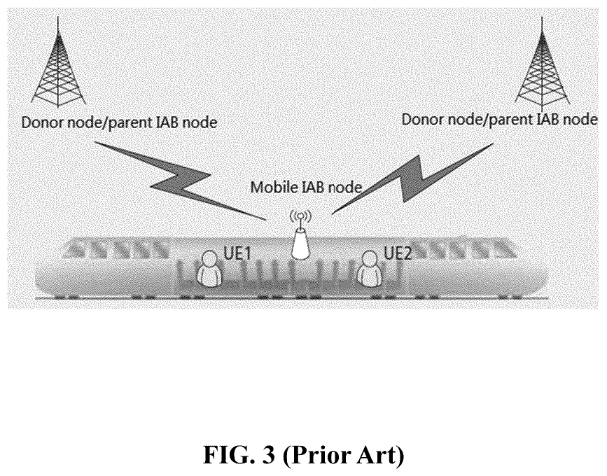

3GPP Technical Specification 38.300 discusses a mobile IAB scenario, as shown in FIG. 3.

IAB enables wireless relaying in Next Generation Radio Access Network (NG-RAN). The relaying node, referred to as IAB-node, supports access and backhauling via NR. The terminating node of NR backhauling on network side is referred to as the IAB-donor, which represents a gNB with additional functionality to support IAB. Backhauling can occur via a single or via multiple hops.

The IAB-node supports gNB-DU (Distributed Unit) functionality as defined in TS 38.401, to terminate the NR access interface to UEs (wireless devices) and next-hop IAB-nodes, and to terminate the F1 protocol to the gNB-CU (Central Unit) functionality, as defined in TS 38.401, on the IAB-donor. The gNB-DU functionality on the IAB-node is also referred to as IAB-DU.

In addition to the gNB-DU functionality, the IAB-node also supports a subset of the UE functionality referred to as IAB-MT, which includes, e.g., physical layer, layer-2, RRC and NAS functionality to connect to the gNB-DU of another IAB-node or the IAB-donor, to connect to the gNB-CU on the IAB-donor, and to the core network.

The IAB-node can access the network using either SA-mode (Standalone Architecture) or EN-DC (E-UTRA-NR Dual Connectivity). In EN-DC, the IAB-node also connects via E-UTRA to a MeNB, and the IAB-donor terminates X2-C as SgNB (TS 37.340).

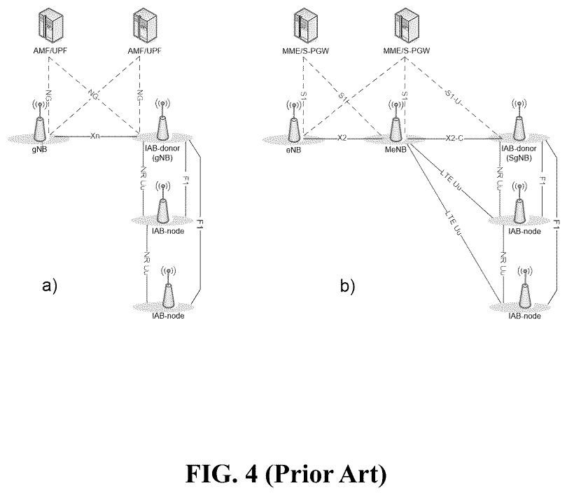

FIG. 4 shows IAB architecture; a) IAB-node using SA mode with NGC; b) IAB-node using EN-DC.

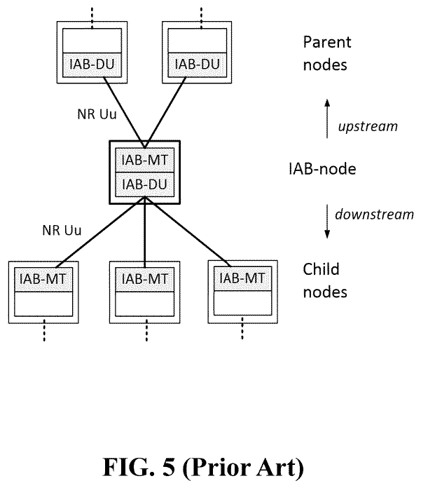

FIG. 5 shows Parent- and child-node relationship for IAB-node.

All IAB-nodes that are connected to an IAB-donor via one or multiple hops form a directed acyclic graph (DAG) topology with the IAB-donor at its root. In this DAG topology, the neighbor node on the IAB-DU's interface is referred to as child node and the neighbor node on the IAB-MT's interface is referred to as parent node. The direction toward the child node is further referred to as downstream while the direction toward the parent node is referred to as upstream. The IAB-donor performs centralized resource, topology, and route management for the IAB topology.

### Table of Technical Terminology

IAB-donor: gNB that provides network access to UEs via a network of backhaul and access links.

IAB-donor-CU: the gNB-CU of an IAB-donor, terminating the F1 interface towards IAB-nodes and IAB-donor-DU.

IAB-donor-DU: the gNB-DU of an IAB-donor, hosting the IAB BAP sublayer, (as defined in TS 38.340), providing wireless backhaul to IAB-nodes.

IAB-DU: gNB-DU functionality supported by the IAB-node to terminate the NR access interface to UEs and next-hop IAB-nodes, and to terminate the F1 protocol to the gNB-CU functionality, as defined in TS 38.401, on the IAB-donor.

IAB-MT: IAB-node function that terminates the Uu interface to the parent node using the procedures and behavior specified for UEs unless stated otherwise. IAB-MT function used in 38-series of 3GPP Specifications corresponds to IAB-UE function defined in TS 23.501.

IAB-node: RAN node that supports NR access links to UEs and NR backhaul links to parent nodes and child nodes. The IAB-node does not support backhauling via LTE.

Child node: IAB-DU's and IAB-donor-DU's next hop neighbor node; the child node is also an IAB-node.

Parent node: IAB-MT's next hop neighbor node; the parent node can be IAB-node or IAB-donor-DU

Upstream: Direction toward parent node in IAB-topology.

Downstream: Direction toward child node or UE in IAB-topology.

### Embodiment 1: or UEs in RRC_CONNECTED

Problem: In mobile IAB scenario, IAB donor is not aware of mobility status of IAB node and UE. In this situation, IAB donor cannot perform handover decision for UE properly. For example, if UE is moving along with IAB node, IAB donor can initiate UE handover along with IAB node migration.

Solution: IAB node sends mobility status information to IAB donor, mobility status information includes at least one of the following: speed information, direction information, serving onboard UE indication, serving surrounding UE's indication, location information; Relative speed of between UE, the mobile IAB node, or UE's mobility status indication.

UE's mobility status indication includes at least one of the following: in the vehicle, outside the vehicle, entering the vehicle, or leaving the vehicle.

UE sends mobility status information to IAB node, mobility status information includes at least one of the following: speed information, direction information, or location information.

UE sends mobility status information to IAB donor, mobility status information includes at least one of the following: speed information, direction information, or location information.

Optionally, mobility status reporting at UE/IAB node could be enabled/disabled by IAB node or IAB donor. In this solution, UE receives mobility status reporting configuration information from IAB node or IAB donor. Or IAB node receives mobility status reporting configuration information from IAB donor. Mobility status reporting configuration information could be delivered via RRC dedicated signaling or system information or MAC CE. Mobility status reporting configuration information includes mobility status reporting enable indication or mobility status reporting disable indication.

For example, when mobile IAB node is moving in high speed, mobility status reporting at UE could be disabled. When mobile IAB node stops, mobility status reporting at UE could be enabled.

If mobility status reporting is enabled at UE, and link quality of serving cell is lower than configured s-measure value, UE sends measurement report to IAB-donor, which includes speed/direction information.

UE sends mobility status report to mobile IAB node (e.g., via MAC CE), and then mobile IAB node sends mobility status report to the IAB donor. The mobility status report from IAD node may include information of multiple UEs.

### Embodiment 2: for IAB-Node/UEs in RRC_CONNECTED

Problem: During IAB node migration, target IAB donor or target parent IAB node cannot perform admission control properly since it is not aware of the mobility status of UE or IAB node.

Solution: target IAB donor or target parent IAB node perform admission control according to UE or IAB node's mobility status.

Step 1: Source IAB-donor-CU sends mobility status information to target donor-CU.

Step 2: Target donor-CU sends mobility status information to target parent IAB node/target donor-DU.

The mobility status information includes at least one of the following: speed information, direction information, serving onboard UE indication, serving surrounding UEs indication, location information, Relative speed of between UE and the mobile IAB node or UE's mobility status indication.

UE's mobility status indication includes at least one of the following: in the vehicle, outside the vehicle, entering the vehicle, or leaving the vehicle.

### Embodiment 3: for UEs in RRC_CONNECTED

Scenario: In inter-donor migration, if UE migration is performed before Mobile Termina (MT) migration, DU/UE migration needs to be performed via source path before MT migration is performed based on indication from CU.

Step 1: IAB-MT receives RRRCreconfiguration message from source IAB donor, which includes at least one of the following: DU migration indication, F1 setup indication, conditional configuration indication for IAB-MT migration, cell information (e.g., Physical Cell ID (PCI) or NR Cell Global Identifier (NCGI)), CU IP address information, IAB-node's BAP address, default BAP configuration, IP address information allocated by source IAB donor (e.g., IPv4 address, IPv6 address, IP address prefix, IP address usage), IP address information allocated by target IAB donor (e.g., IPv4 address, IPv6 address, IP address prefix, IP address usage), or topology indication (e.g., source topology indication, target topology indication, F1-terminating topology indication, non F1-terminating topology indication).

Step 2: IAB-node perform F1 setup with target IAB donor. Optionally, UE handover is performed after IAB node established F1 connection with target IAB donor.

Step 3a: Source donor CU sends MT migration indication to IAB node, e.g., after all UEs have been migrated. Source donor CU could send MT migration indication to IAB node via RRC or F1 message.

Step 3b: Alternatively, target donor CU sends MT migration indication to IAB node, e.g. after all UEs have been migrated. Target donor CU could send MT migration indication to IAB node via F1 message.

Step 4: IAB node applies configuration received via RRRCreconfiguration message in step 1 and performs random access towards target parent node/target donor DU.

### Embodiment 4: for UEs in RRC_CONNECTED

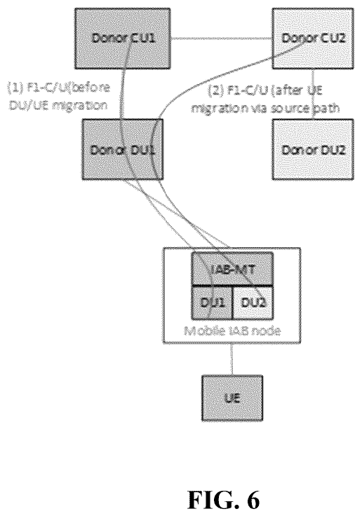

Scenario: In inter-donor migration, if UE migration is performed before MT migration, DU/UE migration needs to be performed via source path before MT migration. In this situation, F1 traffic between IAB-DU and target IAB donor needs to be transferred through source donor DU via source path, e.g., as shown in the green line in FIG. 6.

FIG. 6 shows inter-donor migration-DU/UE migration is performed before MT migration.

Problem: how could DL traffic be transferred from donor CU 2 via donor DU1.

Solution: Information needs to be exchanged between donor CU1 and CU2 to enable DL mapping configuration at donor DU1.

Step 1: source donor CU sends traffic information to target CU, traffic information includes at least one of the following: Quality of Service (QOS) information of UP/non-UP traffic, DSCP (Differentiated Services Code Point), or flow label.

Step 2: target CU sends information for DL mapping to source CU, the information for DL mapping includes at least one of the following: IP address of IAB node, e.g., after receiving IP address from IAB node via F1 message, DSCP (Differentiated Services Code Point), DSCP information is included in step 2 if not included in step 1, or flow label, flow label information is included in step 2 if not included in step 1.

Step 3: source CU configures DL mapping at source donor DU according to the information received from target donor CU.

### Embodiment 5—for UEs in RRC_IDLE/INACTIVE

Problem: Legacy speed dependent scaling mechanism for cell reselection is not applicable for mobile IAB scenario, e.g., when the UE is in the vehicle that is moving along with the mobile IAB node.

Solution 1: UE performs cell reselection based on CU configuration, e.g., speed dependent scaling for cell reselection can be disabled by CU when the mobile IAB node is moving.

Step 1: IAB node sends mobility status information to IAB donor; The mobility status information includes at least one of the following: speed information, direction information, serving onboard UE indication, serving surrounding UEs indication, location information; relative speed of between UE and the mobile IAB node, or UE's mobility status indication.

UE's mobility status indication includes at least one of the following: in the vehicle, outside the vehicle, entering the vehicle, or leaving the vehicle.

Step 2: IAB donor sends cell reselection related configuration information to IAB node or UE. The cell reselection related configuration information includes at least one of the following: speed dependent scaling parameter which is based on the relative speed (e.g., scaling factor for Qhyst and/or scaling factor for Treselection), speed dependent scaling mechanism enable indication, or speed dependent scaling mechanism disable indication.

Step 3: IAB node or UE performs cell reselection based on the cell reselection related configuration information.

Solution 2: UE performs cell reselection based on relative speed or speed of mobile IAB node.

Step 1: The mobile IAB node broadcasts its mobility status information, which includes at least one of the following: speed information, direction information, serving onboard UE indication, serving surrounding UEs indication, location information; speed dependent scaling parameter which is based on the relative speed (e.g., scaling factor for Qhyst and/or scaling factor for treselection), or threshold of speed of mobile IAB node (e.g., UE disable speed dependent scaling mechanism (which is based on UE mobility state) when the speed of the mobile IAB node is larger than configured threshold value).

Step 2: UE performs cell reselection based on relative speed between UE and IAB node, or based on mobility status of mobile IAB node.

For example, UE disable speed dependent scaling mechanism (which is based on UE mobility state) when the speed of the mobile IAB node is larger than 0, UE disable speed dependent scaling mechanism (which is based on UE mobility state) when the speed of the mobile IAB node is larger than configured threshold value, UE use speed dependent scaling parameter which is based on the relative speed to perform cell reselection, or when the speed of mobile IAB node equals zero, UE perform cell reselection based on speed dependent scaling mechanism which is based on absolute speed of UE.

Accordingly, some preferred embodiments may use the following solutions.

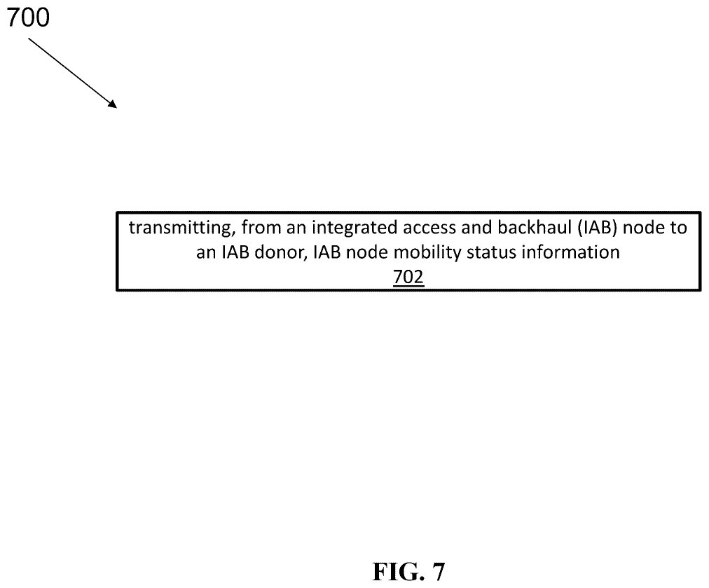

1. A method of wireless communication (e.g., method 700 depicted in FIG. 7) including transmitting, from an integrated access and backhaul (IAB) node to an IAB donor, IAB node mobility status information (702). Additional details and examples are discussed with respect to Embodiment 1X.

2. The method of solution 1 further comprising, receiving, prior to the transmitting of the IAB node mobility status information, by the IAB donor, a mobility status reporting configuration information.

3. The method of solution 1, wherein the IAB node mobility status information includes at least one of the following: speed information, direction information, location information, serving onboard wireless device indication, serving surrounding wireless device indication, relative speed between the wireless device and the IAB node, or mobility status indication.

4. The method of solution 3, wherein the mobility status indication includes at least one of the following: within a vehicle, outside of the vehicle, enter the vehicle, or leave the vehicle.

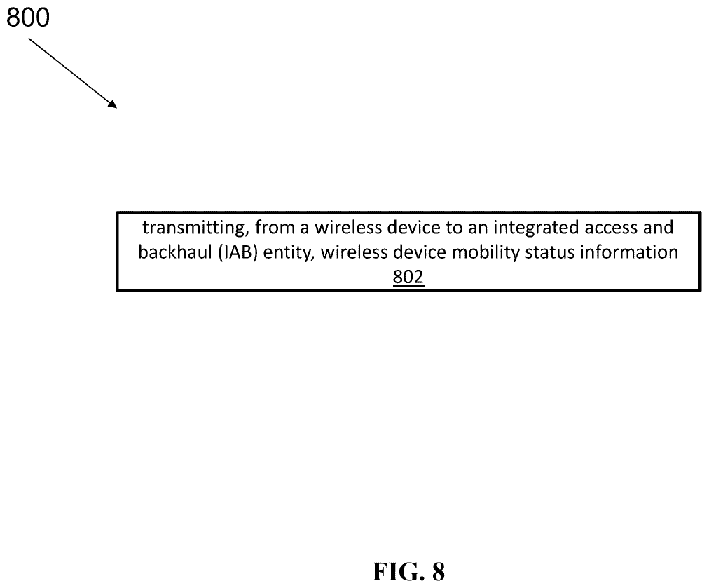

5. A method of wireless communication (e.g., method 800 depicted in FIG. 8) including: transmitting, from a wireless device to an integrated access and backhaul (IAB) entity, wireless device mobility status information (802). Additional details and examples are discussed with respect to Embodiment 1.

6. The method of solution 5 further comprising: receiving, prior to the transmitting of the wireless device mobility status information, by the wireless device, a mobility status reporting configuration information.

7. The method of solution 6, wherein the wireless device mobility status information includes at least one of the following: speed information, direction information, or location information, relative speed between the wireless device and the IAB node, or mobility status indication; wherein the mobility status indication includes at least one of the following: within a vehicle, outside of the vehicle, enter the vehicle, or leave the vehicle.

8. The method of solution 5, wherein the IAB entity comprising an IAB node or an IAB donor.

9. The method of any of solutions 2 or 6, wherein the mobility status reporting configuration information includes enabling or disabling mobility status reporting.

10. The method of any of solutions 1, 5, or 8, wherein IAB donor further comprising a first IAB donor central unit (CU) and a second IAB donor CU; transmitting, from the first IAB donor CU to the second IAB donor CU, the IAB node or the wireless device mobility status information; and wherein the IAB node or the wireless device mobility status information includes at least one of the following: speed information, direction information, location information, serving onboard wireless device indication, serving surrounding wireless devices indication, relative speed between wireless device and IAB node, or mobility status indication.

11. The method of solution 10 further comprising: transmitting, from the second IAB donor CU to a IAB node or a donor distributed unit (DU), the mobility status information.

12. The method of solution 10, wherein the first IAB donor CU transmits to the second IAB donor CU at least one of the following: Quality of Service (QOS) information, Differentiated Services Code Point (DSCP); flow label, or IP address of an IAB node.

13. The method of solution 12 further comprising: receiving, by the first IAB donor CU from the second IAB donor CU, downlink mapping information; and wherein the downlink mapping information includes at least one of the following: IP address information of IAB node, DSCP, or flow label.

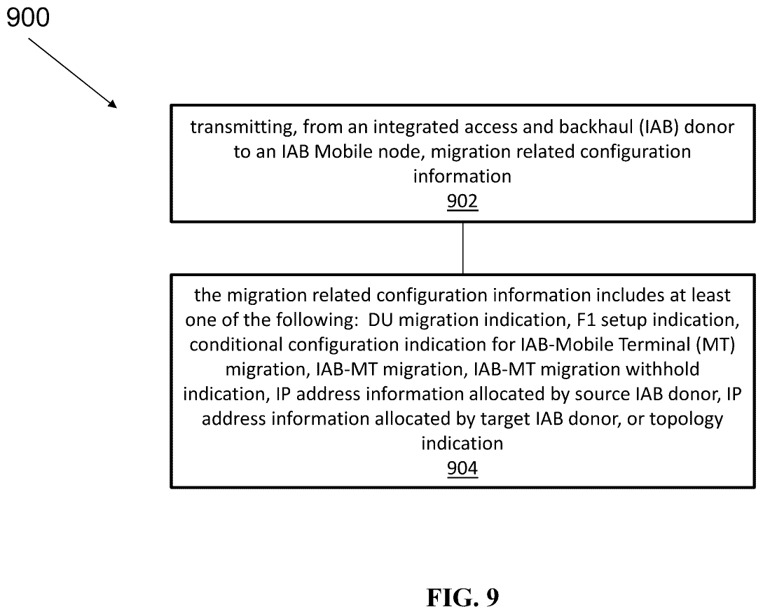

14. A method of wireless communication (e.g., method 900 depicted in FIG. 9) including: transmitting, from an integrated access and backhaul (IAB) donor to an IAB Mobile node, migration related configuration information (902); and wherein the migration related configuration information includes at least one of the following: DU migration indication, F1 setup indication, conditional configuration indication for IAB-Mobile Terminal (MT) migration, IAB-MT migration, IAB-MT migration withhold indication, IP address information allocated by source IAB donor, IP address information allocated by target IAB donor, or topology indication (904). Additional details and examples are discussed with respect to Embodiment 3.

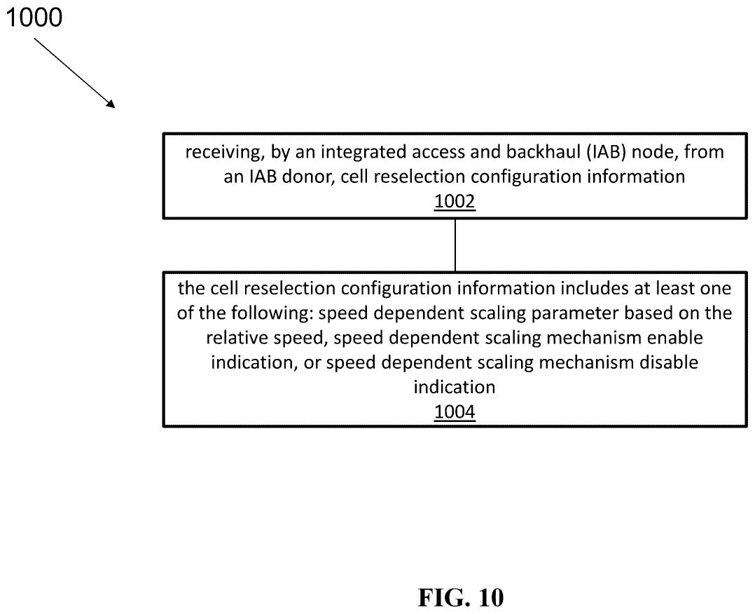

15. A method of wireless communication (e.g., method 1000 depicted in FIG. 10) including: receiving, by an integrated access and backhaul (IAB) node, from an IAB donor, cell reselection configuration information (1002); and wherein the cell reselection configuration information includes at least one of the following: speed dependent scaling parameter based on the relative speed, speed dependent scaling mechanism enable indication, or speed dependent scaling mechanism disable indication (1004). Additional details and examples are discussed with respect to Embodiment 5.

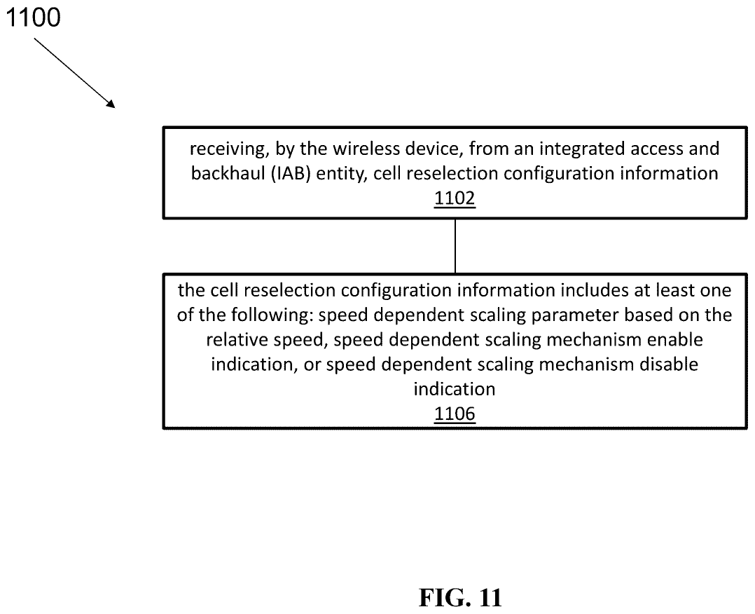

16. A method of wireless communication (e.g., method 1100 depicted in FIG. 11) including: receiving, by the wireless device, from an integrated access and backhaul (IAB) entity, cell reselection configuration information (1102); and wherein the cell reselection configuration information includes at least one of the following: speed dependent scaling parameter based on the relative speed, speed dependent scaling mechanism enable indication, or speed dependent scaling mechanism disable indication (1104). Additional details and examples are discussed with respect to Embodiment 5.

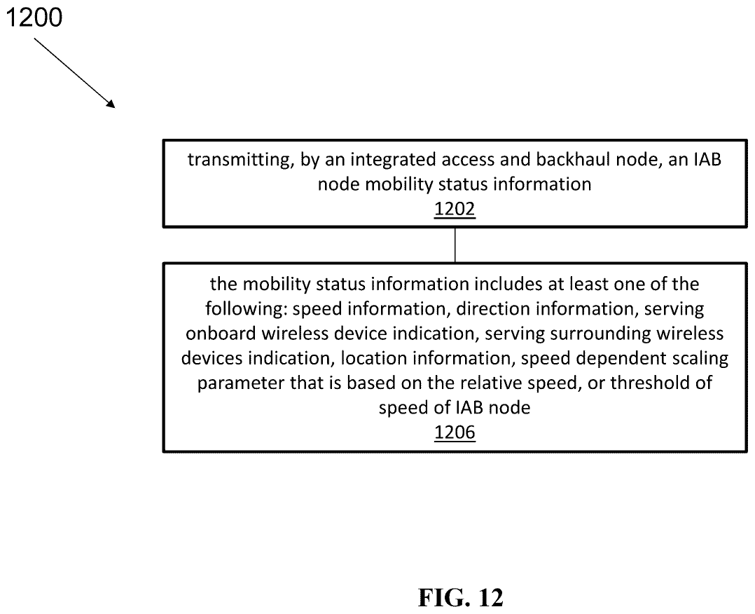

17. A method of wireless communication (e.g., method 1200 depicted in FIG. 12) including: transmitting, by an integrated access and backhaul node, an IAB node mobility status information (1202); and wherein the mobility status information includes at least one of the following: speed information, direction information, serving onboard wireless device indication, serving surrounding wireless devices indication, location information, speed dependent scaling parameter that is based on the relative speed, or threshold of speed of IAB node (1204). Additional details and examples are discussed with respect to Embodiment 5.

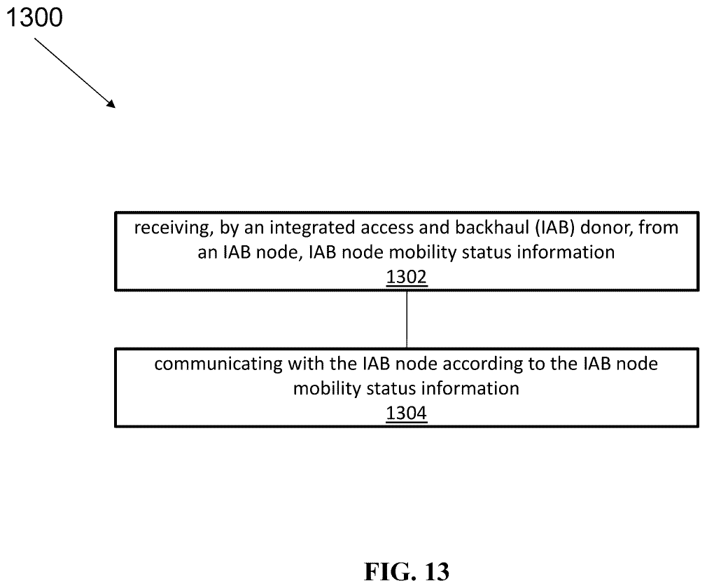

18. A method of wireless communication (e.g., method 1300 depicted in FIG. 13) including receiving, by an integrated access and backhaul (IAB) donor, from an IAB node, IAB node mobility status information (1302); and communicating with the IAB node according to the IAB node mobility status information (1304). Additional details and examples are discussed with respect to Embodiment 1.

19. The method of solution 18 further comprising: transmitting, prior to the transmitting of the IAB node mobility status information, from the IAB donor, a mobility status reporting configuration information.

20. The method of solution 18, wherein the IAB node mobility status information includes at least one of the following: speed information, direction information, location information, serving onboard wireless device indication, serving surrounding wireless device indication, relative speed between the wireless device and the IAB node, or mobility status indication.

21. The method of solution 20, wherein the mobility status indication includes at least one of the following: within a vehicle, outside of the vehicle, enter the vehicle, or leave the vehicle.

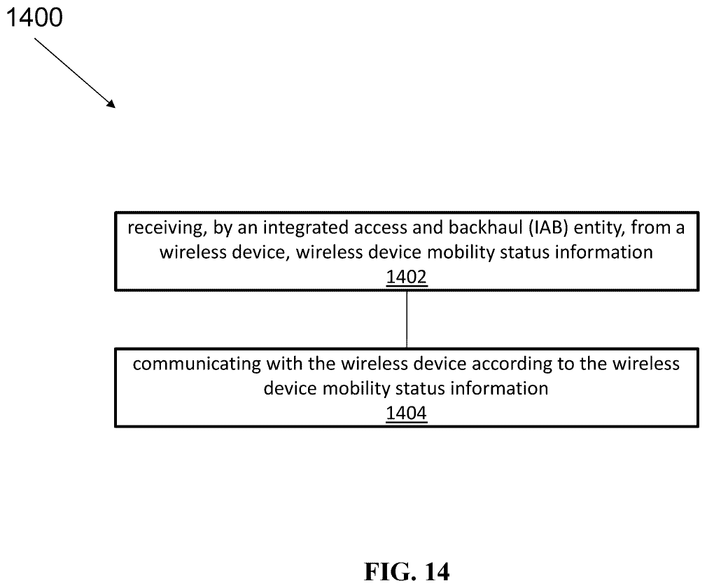

22. A method of wireless communication (e.g., method 1400 depicted in FIG. 14) including: receiving, by an integrated access and backhaul (IAB) entity, from a wireless device, wireless device mobility status information (1402); and communicating with the wireless device according to the wireless device mobility status information (1404). Additional details and examples are discussed with respect to Embodiment 1.

23. The method of solution 22 further comprising: transmitting, prior to the receiving of the wireless device mobility status information, by the wireless device, a mobility status reporting configuration information.

24. The method of solution 22, wherein the wireless device mobility status information includes at least one of the following: speed information, direction information, or location information, relative speed between the wireless device and the IAB node, or mobility status indication, and wherein the mobility status indication includes at least one of the following: within a vehicle, outside of the vehicle, enter the vehicle, or leave the vehicle.

25. The method of solution 22, wherein the IAB entity comprising an IAB node or an IAB donor.

26. The method of any of solutions 19 or 23, wherein the mobility status reporting configuration information includes enabling or disabling mobility status reporting.

27. The method of any of solutions 18, 22, or 25, wherein IAB donor further comprising a first IAB donor central unit (CU) and a second IAB donor CU; receiving, by the second IAB donor CU from the first IAB donor CU, the IAB node or the wireless device mobility status information; and wherein the IAB node or the wireless device mobility status information includes at least one of the following: speed information, direction information, location information, serving onboard wireless device indication, serving surrounding wireless devices indication, relative speed between wireless device and IAB node, or mobility status indication.

28. The method of solution 27 further comprising: receiving, by a IAB node or a donor distributed unit (DU), from the second IAB donor CU, the mobility status information.

29. The method of solution 27, wherein the source IAB donor CU transmits to the target IAB donor CU at least one of the following: Quality of Service (QOS) information, Differentiated Services Code Point (DSCP); flow label, or IP address of an IAB node.

30. The method of claim 29 further comprising: transmitting, to the source IAB donor CU from the target IAB donor CU, downlink mapping information; and wherein the downlink mapping information includes at least one of the following: IP address information of IAB node, DSCP, or flow label.

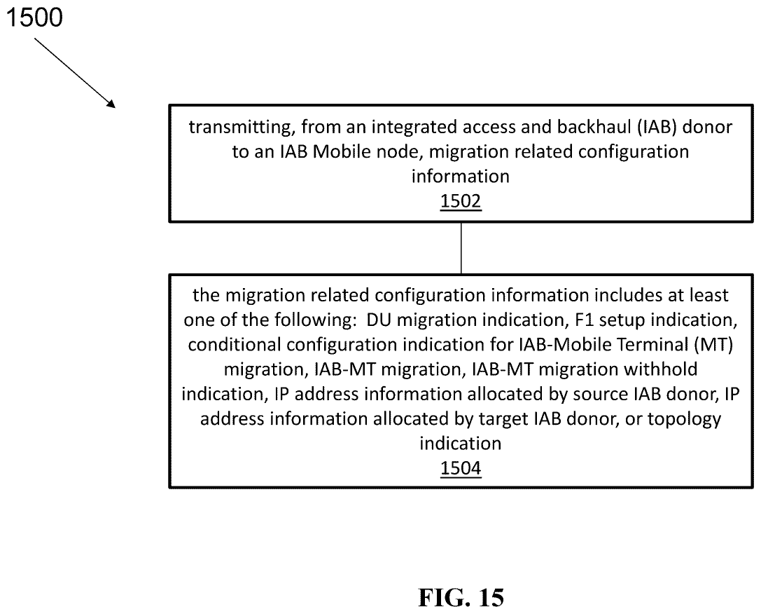

31. A method of wireless communication (e.g., method 1500 depicted in FIG. 15) including transmitting, from an integrated access and backhaul (IAB) donor to an IAB Mobile node, migration related configuration information (1502); and wherein the migration related configuration information includes at least one of the following: DU migration indication, F1 setup indication, conditional configuration indication for IAB-Mobile Terminal (MT) migration, IAB-MT migration, IAB-MT migration withhold indication, IP address information allocated by source IAB donor, IP address information allocated by target IAB donor, or topology indication (1504). Additional details and examples are discussed with respect to Embodiment 3.

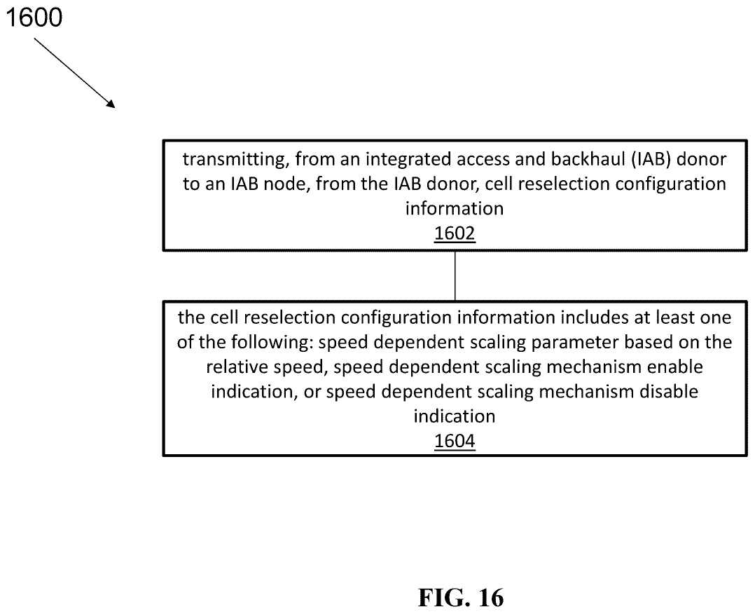

32. A method of wireless communication (e.g., method 1600 depicted in FIG. 16) including: transmitting, from an integrated access and backhaul (IAB) donor to an IAB node, from the IAB donor, cell reselection configuration (1602); and wherein the cell reselection configuration information includes at least one of the following: speed dependent scaling parameter based on the relative speed, speed dependent scaling mechanism enable indication, or speed dependent scaling mechanism disable indication (1604). Additional details and examples are discussed with respect to Embodiment 5.

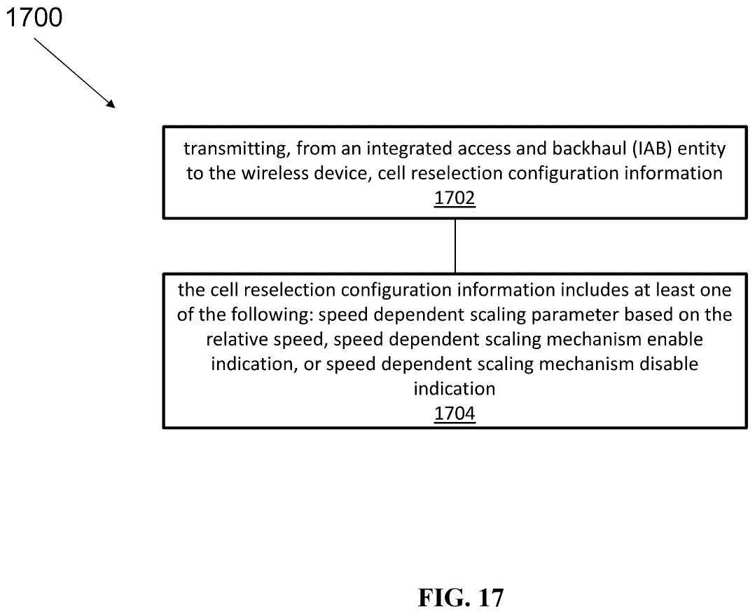

33. A method of wireless communication (e.g., method 1700 depicted in FIG. 17) including: transmitting, from an integrated access and backhaul (IAB) entity to the wireless device, cell reselection configuration information (1702); and wherein the cell reselection configuration information includes at least one of the following: speed dependent scaling parameter based on the relative speed, speed dependent scaling mechanism enable indication, or speed dependent scaling mechanism disable indication (1704). Additional details and examples are discussed with respect to Embodiment 5.

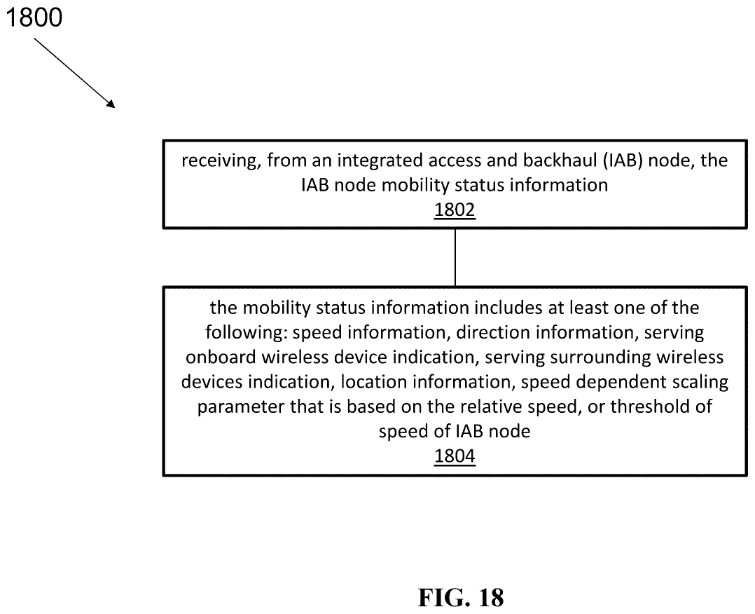

34. A method of wireless communication (e.g., method 1800 depicted in FIG. 18) including: receiving, from an integrated access and backhaul (IAB) node, the IAB node mobility status information (1802); wherein the mobility status information includes at least one of the following: speed information, direction information, serving onboard wireless device indication, serving surrounding wireless devices indication, location information, speed dependent scaling parameter that is based on the relative speed, or threshold of speed of IAB node (1804). Additional details and examples are discussed with respect to Embodiment 5.

35. A communication apparatus comprising a processor configured to implement a method recited in any one or more of claims 1 to 34.

35. An apparatus for wireless communication comprising a processor configured to implement the method of any of claims 1 to 34.

36. A computer readable medium having code stored thereon, the code when executed by a processor, causing the processor to implement a method recited in any of claims 1 to 34.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

What is claimed is:

1. A method of wireless communication, comprising:
transmitting, from an integrated access and backhaul (IAB) node to an IAB donor, IAB node mobility status information.

2. The method of claim 1 further comprising:
receiving, prior to the transmitting of the IAB node mobility status information, from the IAB donor, a mobility status reporting configuration information,
wherein the mobility status reporting configuration information includes enabling or disabling mobility status reporting.

3. The method of claim 1, wherein the IAB node mobility status information includes at least one of the following: speed information, direction information, location information, serving onboard wireless device indication, serving surrounding wireless devices indication, relative speed between the wireless device and the IAB node, speed dependent scaling parameter that is based on the relative speed, threshold of speed of IAB node, or mobility status indication; and
wherein the mobility status indication includes at least one of the following: within a vehicle, outside of the vehicle, enter the vehicle, or leave the vehicle.

4. A method of wireless communication, comprising:
receiving, by an integrated access and backhaul (IAB) donor, from an IAB node, IAB node mobility status information; and
communicating with the IAB node according to the IAB node mobility status information.

5. The method of claim 4, further comprising:
transmitting, prior to the receiving of the IAB node mobility status information, from the IAB donor, a mobility status reporting configuration information,
wherein the mobility status reporting configuration information includes enabling or disabling mobility status reporting.

6. The method of claim 4, wherein the IAB node mobility status information includes at least one of the following: speed information, direction information, location information, serving onboard wireless device indication, serving surrounding wireless device indication, relative speed between the wireless device and the IAB node, or mobility status indication; and
wherein the mobility status indication includes at least one of the following: within a vehicle, outside of the vehicle, enter the vehicle, or leave the vehicle.

7. The method of claim 4, wherein the IAB donor comprises a first IAB donor central unit (CU) and a second IAB donor CU;
the method further comprising:
receiving, by the second IAB donor CU from the first IAB donor CU, the IAB node mobility status information,
wherein the IAB node mobility status information includes at least one of the following: speed information, direction information, location information, serving onboard wireless device indication, serving surrounding wireless devices indication, relative speed between wireless device and IAB node, or mobility status indication.

8. The method of claim 7, further comprising:
transmitting, from the second IAB donor CU to a IAB node or a donor distributed unit (DU), the IAB node mobility status information.

9. The method of claim 7, wherein the second IAB donor CU receives from the first IAB donor CU at least one of the following: Quality of Service (QOS) information, Differentiated Services Code Point (DSCP), flow label, or IP address of an IAB node;
the method further comprising:
transmitting, to the first IAB donor CU from the second IAB donor CU, downlink mapping information,
wherein the downlink mapping information includes at least one of the following: IP address information of an IAB node, DSCP, or flow label.

10. The method of claim 4, further comprising:
transmitting, from the IAB donor to an IAB Mobile node, migration related configuration information,
wherein the migration related configuration information includes F1 setup indication or CU IP address information.

11. The method of claim 4, further comprising:
transmitting, from the IAB donor to an IAB node, cell reselection configuration information; and
wherein the cell reselection configuration information includes at least one of the following: speed dependent scaling parameter based on the relative speed, speed dependent scaling mechanism enable indication, or speed dependent scaling mechanism disable indication.

12. A method of wireless communication, comprising:
receiving, by an integrated access and backhaul (IAB) entity, from a wireless device, wireless device mobility status information; and
communicating with the wireless device according to the wireless device mobility status information,
wherein the IAB entity comprises an IAB node or an IAB donor.

13. The method of claim 12 further comprising:
transmitting, prior to the receiving of the wireless device mobility status information, from the IAB entity, a mobility status reporting configuration information,
wherein the mobility status reporting configuration information includes enabling or disabling mobility status reporting.

14. The method of claim 12, wherein the wireless device mobility status information includes at least one of the following: speed information, direction information, or location information, relative speed between the wireless device and the IAB node, or mobility status indication; and
wherein the mobility status indication includes at least one of the following: within a vehicle, outside of the vehicle, enter the vehicle, or leave the vehicle.

15. The method of claim 12, wherein the IAB donor comprises a first IAB donor central unit (CU) and a second IAB donor CU;
the method further comprising:
receiving, by the second IAB donor CU from the first IAB donor CU, the wireless device mobility status information,
wherein the wireless device mobility status information includes at least one of the following: speed information, direction information, location information, serving onboard wireless device indication, serving surrounding wireless devices indication, relative speed between wireless device and IAB node, or mobility status indication.

16. The method of claim 15 further comprising:
transmitting, from the second IAB donor CU to a IAB node or a donor distributed unit (DU), the wireless device mobility status information.

17. The method of claim 15, wherein the second IAB donor CU receives from the first IAB donor CU at least one of the following: Quality of Service (QOS) information, Differentiated Services Code Point (DSCP); flow label, or IP address of an IAB node;
the method further comprising:
transmitting, to the first IAB donor CU from the second IAB donor CU, downlink mapping information,
wherein the downlink mapping information includes at least one of the following: IP address information of an IAB node, DSCP, or flow label.

18. The method of claim 12, further comprising:
transmitting, from the IAB entity to the wireless device, cell reselection configuration information; and
wherein the cell reselection configuration information includes at least one of the following: speed dependent scaling parameter based on the relative speed, speed dependent scaling mechanism enable indication, or speed dependent scaling mechanism disable indication.

19. A wireless communication apparatus, comprising at least one processor configured to:
transmit, to an IAB donor, IAB node mobility status information; and
receive, prior to the transmitting of the IAB node mobility status information, from the IAB donor, a mobility status reporting configuration information,
wherein the mobility status reporting configuration information includes enabling or disabling mobility status reporting.

20. The apparatus of claim 19, wherein the IAB node mobility status information includes at least one of the following: speed information, direction information, location information, serving onboard wireless device indication, serving surrounding wireless devices indication, relative speed between the wireless device and the IAB node, speed dependent scaling parameter that is based on the relative speed, threshold of speed of IAB node, or mobility status indication, and
wherein the mobility status indication includes at least one of the following: within a vehicle, outside of the vehicle, enter the vehicle, or leave the vehicle.
